(19) United States
(12) Patent Application Publication
(10) Pub. No.: US 2011/0321075 A1
(43) Pub. Date: Dec. 29, 2011

(54) DYNAMICALLY MODIFYING MEDIA CONTENT FOR PRESENTATION TO A GROUP AUDIENCE

(75) Inventors: RICHARD A. BRUNKHORST, RALEIGH, NC (US); JOEL DUQUENE, RALEIGH, NC (US); ERIC P. HAMBRIGHT, RALEIGH, NC (US); XINXIN SHENG, CARY, NC (US)

(73) Assignee: INTERNATIONAL BUSINESS MACHINES CORPORATION, ARMONK, NY (US)

(21) Appl. No.: 12/825,845

(22) Filed: Jun. 29, 2010

(51) Int. Cl. H04H 60/33; H04N 7/16

(52) U.S. Cl. 725/13; 725/25

(57) ABSTRACT

A computer implemented method dynamically modifies media content to be presented to a group of viewers. A plurality of content filters, each of which has multiple sub-components and is based on a member profile of a different member of a media viewing audience, is generated. Media content is then modified, based on the plurality of content filters, to create a dynamically modified media content for viewing by the media viewing audience.

### BACKGROUND

The present disclosure relates to the field of computers, and specifically to the use of computers to modify media content. Still more particularly, the present disclosure relates to the use of computers to modify media content in order to make it appropriate for a group audience.

### BRIEF SUMMARY

In one embodiment of the present disclosure, a computer implemented method dynamically modifies media content to be presented to a group of viewers. A plurality of content filters, each of which has multiple sub-components and is based on a member profile of a different member of a media viewing audience, is generated. Media content is then modified, based on the plurality of content filters, to create a dynamically modified media content for viewing by the media viewing audience.

In one embodiment of the present disclosure, a computer system comprises: a central processing unit; and a memory coupled to the central processing unit, wherein the memory comprises software that, when executed, causes the central processing unit to implement: generating a plurality of content filters, wherein each of the content filters is based on a member profile of a different member of a media viewing audience; modifying a media content to create a dynamically modified media content based on the plurality of content filters; and transmitting the dynamically modified media content to a playback device that is used to display the dynamically modified media content to the media viewing audience.

In one embodiment of the present disclosure, a computer program product comprises: a computer readable storage medium having computer readable program code embodied therewith, the computer readable program code comprising: computer readable program code to generate a plurality of content filters, wherein each of the content filters is based on a member profile of a different member of a media viewing audience; computer readable program code to modify a media content to create a dynamically modified media content based on the plurality of content filters; and computer readable program code to transmit the dynamically modified media content to a playback device that is used to display the dynamically modified media content to the media viewing audience.

### BRIEF DESCRIPTION OF THE SEVERAL VIEWS OF THE DRAWINGS

FIG. 1 depicts an exemplary computer in which the present disclosure may be implemented;

FIG. 2 illustrates an exemplary networked system in which a media content modifying computer dynamically modifies media content in accordance with viewer profiles received from multiple guardians' computers; and

FIG. 3 is a high level flow chart of one or more exemplary steps taken by a computer to dynamically modify media content that is being presented to a group of viewers.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

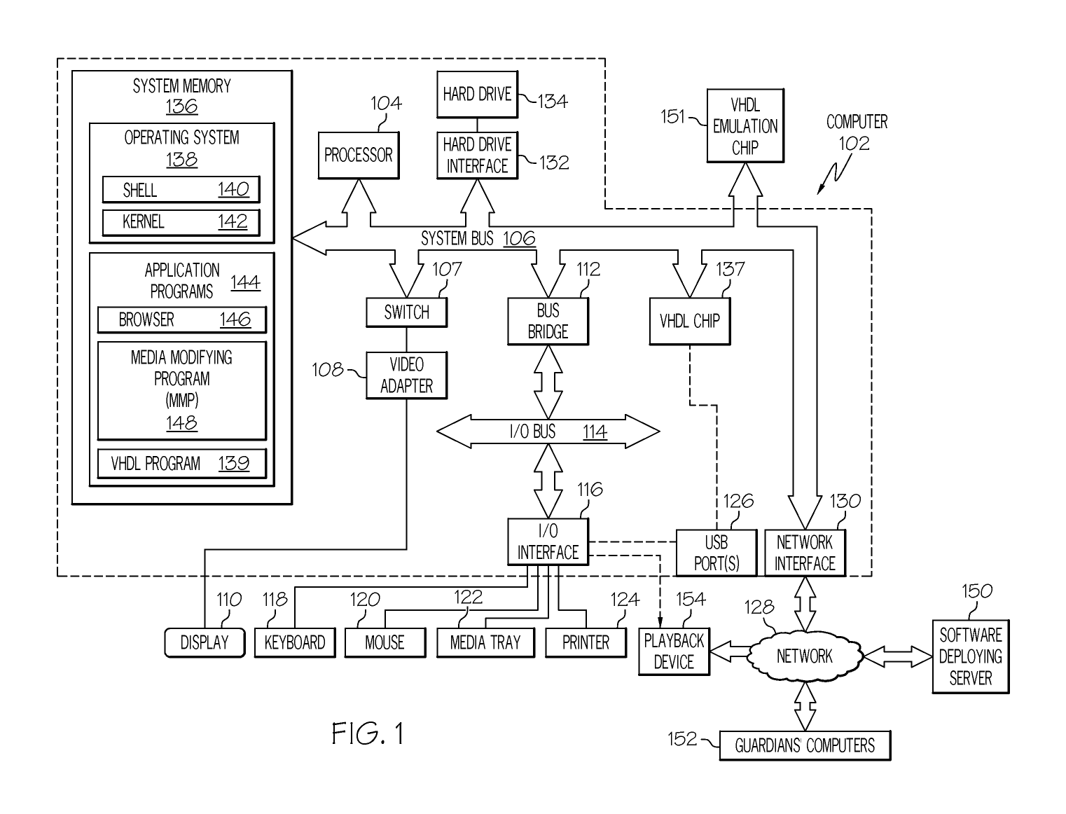

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or guardians' computers 152.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, which may be mechanical, that allows the display 110 to be coupled to the system bus 106, and thus to be functional only upon execution of instructions (e.g., media modifying program—MMP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in one embodiment some or all of these ports are universal serial bus (USB) ports. A playback device 154, such as a projector, an audio player, etc., may be coupled to the I/O interface 116, or it may be remotely coupled to computer 102 via network 128. Note further that playback device 154 may be coupled to a remote computer (not shown), which is coupled to computer 102.

As depicted, computer 102 is able to communicate with a software deploying server 150 and/or guardians' computers 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

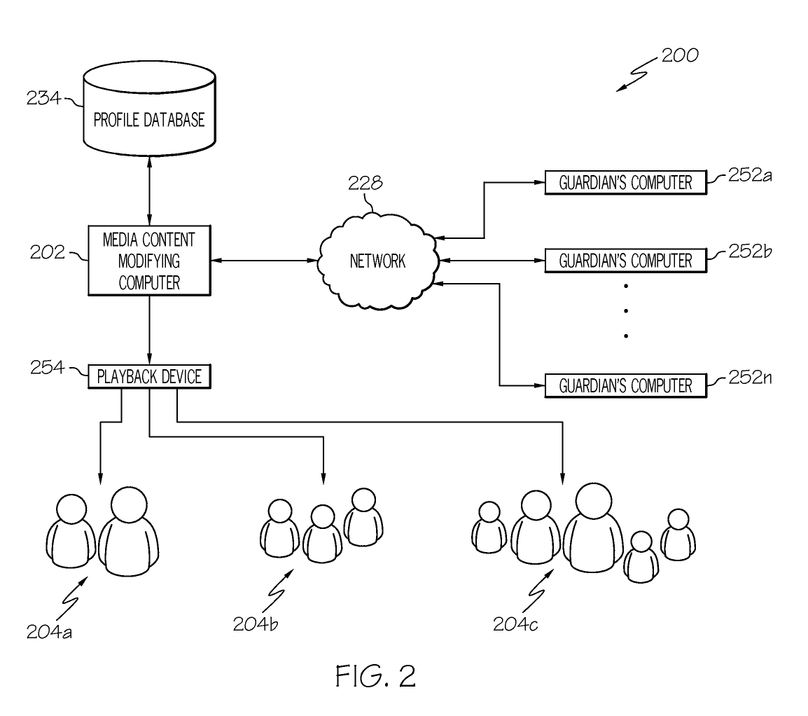

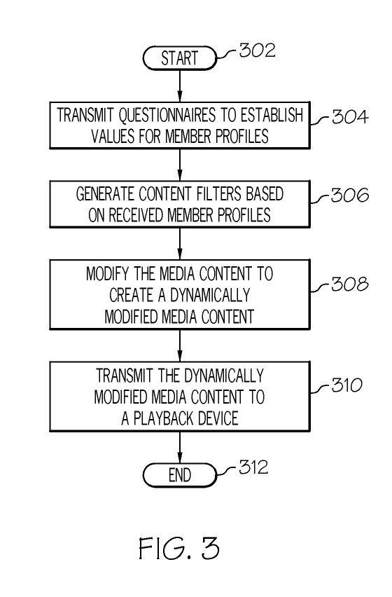

Application programs 144 in computer 102's system memory (as well as software deploying server 150's system memory) also include a media modifying program (MMP) 148. MMP 148 includes code for implementing the processes described below, including those described in FIGS. 2-3. In one embodiment, computer 102 is able to download MMP 148 from software deploying server 150, including in an on-demand basis, such that the code from MMP 148 is not downloaded until runtime or otherwise immediately needed by computer 102. Note further that, in one embodiment of the present disclosure, software deploying server 150 performs all of the functions associated with the present disclosure (including execution of MMP 148), thus freeing computer 102 from having to use its own internal computing resources to execute MMP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from MMP 148 causes VHDL program 139 to configure VHDL chip 137, which may be an FPGA, ASIC, etc.

In another embodiment of the present disclosure, execution of instructions from MMP 148 results in a utilization of VHDL program 139 to program a VHDL emulation chip 151. VHDL emulation chip 151 may incorporate a similar architecture as described above for VHDL chip 137. Once MMP 148 and VHDL program 139 program VHDL emulation chip 151, VHDL emulation chip 151 performs, as hardware, some or all functions described by one or more executions of some or all of the instructions found in MMP 148. That is, the VHDL emulation chip 151 is a hardware emulation of some or all of the software instructions found in MMP 148. In one embodiment, VHDL emulation chip 151 is a programmable read only memory (PROM) that, once burned in accordance with instructions from MMP 148 and VHDL program 139, is permanently transformed into a new circuitry that performs the functions needed to perform the process described below in FIGS. 2-3.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

With reference now to FIG. 2, an exemplary networked system 200 in which a media content modifying computer 202 dynamically modifies media content in accordance with viewer profiles received from multiple guardian's computers 252a-n is presented. Note that in one embodiment elements 202, 228, 234, 252a-n, and 254 depicted in FIG. 2 are analogous to, or at least utilize, corresponding elements 102, 128, 134, 152, and 154 shown in FIG. 1. In one embodiment, media content modifying computer 202 receives information needed to create multiple viewer profiles from guardians' computers 252a-n (where “n” is an integer). In another embodiment, media content modifying computer 202 receives the actual multiple viewer profiles from guardians' computers 252a-n. Guardian's computers 252a-n are utilized by guardians of potential viewers of some type of media content, such as movies, music, pictures of artwork, books, television shows, etc. For purposes of the present disclosure, the term “guardian” is defined as any person having authority, whether actual, apparent, implied, or even invalid, to decide what media content is appropriate for a specific person to watch/hear/read/etc. That is, the guardian may or may not have legal rights to make this decision, but is nonetheless the person who generates audience member profiles, or at least provides information to the media content modifying computer 202 to generate audience member profiles, which are related to members of a media viewing audience. Note further that the term “viewing audience” as used in the present disclosure is defined as an audience of multiple individuals that are exposed to any type of media, including movies, television shows, music, audio books, printed books, photographs, etc. Thus the term “viewing” is defined as seeing, hearing, reading, etc. the media content, and is not limited to just seeing the media content.

Each guardian transmits a member profile, or information for creating that member profile, for a specific person to the media content modifying computer 202. Described below are various methods for creating these profiles. The multiple member profiles are then stored in the profile database 234, and utilized by the media content modifying computer 202 to convert an original version of a media content into a dynamically modified media content. This dynamically modified media content is then transmitted to a playback device 254 (e.g., a video screen, a projector, an audio player, etc.) in a form that is specifically tailored for a particular audience and their profiles. For example, media viewing audience 204a may have a collective profile that allows them to see an unedited version of the original media content, while media viewing audience 204b may be made up of younger persons whose profiles direct the media content modifying computer 202 to delete certain passages from the original media content. Similarly, based on their profiles, media viewing audience 204c may be determined to be an even more sensitive group of viewers, and thus the original media content is limited even further.

While the present disclosure has been presented above in an embodiment in which one party (a guardian) decides what content is appropriate for another (the viewer), in another embodiment the guardian and the viewer are the same person. That is, a person can specify, to the media content modifying computer 202, what type of content he does or does not want to be exposed to.

In one embodiment of the present disclosure, modification of original media content is performed in the following manner. First, certain passages of the original media content are pre-determined to contain potentially sensitive material, based on one or more of the parameters described herein (e.g., violence, profanity, etc.). Each such sensitive passage is tagged in order to identify the passage, how long the passage is (i.e., where the passage starts and stops within the original media content), as well as the sensitivity ratings for that passage. Thus, a particular passage may be identified as “Section 238”, starting at 1 hour, three minutes, and 4 seconds into the movie, ending at 1 hour, three minutes, and 58 seconds into the movie, and having a rating of 7 for violence and 3 for language. Next, acceptable sensitivity levels, found in each viewer's profile, are then applied to each pre-determined passage, in order to determine which, if any, passages are inappropriate for one or more viewers in the audience. When a passage is deemed to be inappropriate for the audience, then media content modifying computer 202 causes that passage to be skipped over, such that the audience is not exposed to that passage.

With reference now to FIG. 3, a high level flow chart of one or more exemplary steps taken by a computer to dynamically modify media content that is being presented to a group of viewers is presented. The process begins at initiator block 302, which may be prompted by an organization, such as a school, club, etc., requesting an audience-appropriate version of media content, such as a particular movie, television show, music, etc. This audience-appropriate version is created based on the profiles of the members of the audience. In one embodiment, these profiles can be created based on electronic questionnaires that have been completed by guardians (as defined herein) of members of the audience (block 304).

These questionnaires described in block 304 may contain questions about different parameters to define multiple sub-components of content filters. For example, each content filter that is ultimately generated (block 306) may contain multiple sub-components that filter different parameters of the media content. Thus, the questionnaire (and ultimately the content filter) may have one component for violence, one for profanity, one for worldviews being discussed, presented, displayed and/or promoted, etc. In one embodiment, each of the sub-components utilizes a sliding scale to qualitatively describe an acceptable amount of questionable content from an original version of the media content. Questionable content is defined as content that has been predefined as content that has been deemed to be inappropriate for audience members whose profiles indicate an intolerance for content related to a particular category. In one embodiment, a sub-component has a sliding scale, such as 1-10, with 10 being the most restrictive (i.e., removing any suggestion of questionable material related to the parameter associated with that sub-component) and 1 being the least restrictive (i.e., no material within that parameter is deemed inappropriate and thus there is no need remove related content).

Note further that the sub-components may be highly granular. That is, rather than simply have a single parameter/component for “violence”; one embodiment of the present disclosure has multiple parameters/sub-components for “violence”, such as “animation violence”, “military violence”, “contact sports violence”, etc. One type of violence may be acceptable to the guardian of a young viewer (e.g., cartoon/animation violence) while another type of violence (e.g., sports violence) may not be inappropriate for this young viewer. Thus, the guardian or other responder to the questionnaire can convey this highly granular information to the media modifier for use in modifying the media content.

Continuing with the reference to block 304, there are multiple types of questionnaires that can be used to determine what the appropriate content is for a specific audience member. For example, the questionnaire can ask the responder to select various movies, books, television shows, video games, music, etc. that have been deemed to be generally appropriate or inappropriate for that specific audience member. By utilizing this information, the media content modifying computer 202 shown in FIG. 2 can determine, in a manner described below, which parts of the media content are appropriate or inappropriate for each member of the audience, as well as for the entire audience.

In order to effectively utilize feedback from the questionnaire, each of the presented examples of movies, books, etc. has been pre-established with a content rating, which may be set by the media content modifying computer 202. For example, assume that Movie A and Movie B have both been rated as containing level 7 (on a scale of 1-10) military violence. If a responder to a questionnaire states that Movie A and Movie B are inappropriate for a minor, then sections of Movie X (which is proposed for viewing) that have been pre-tagged with military violence of levels at 7 or above will be deleted (or skipped over) from the original version of Movie X. Note that in one embodiment, there is a type-to-type correlation between content presented in the questionnaire, while in another embodiment, there is not a type-to-type correlation. That is, a questionnaire may ask the respondent guardian to state which video games are approved for a specific audience member. The information gathered by this questionnaire (related to questions about video games) can then be used to determine whether content from another media (i.e., a movie, book, music, etc.) need to be modified. Thus, if a video game is deemed to have inappropriate military violence, then any book, movie, television show, music, etc. having the same level of inappropriate military violence will be edited accordingly.

With reference now to block 308, an original version of the media content (i.e., movies, books, television shows, music, etc.) is modified, based on the content filters for all of the members of the audience, to create a dynamically modified media content. As described herein, these content filters are based on the member profiles of the audience members. The member profiles describe an acceptable level of questionable material (e.g., violence, language, etc.) that has been determined for each of the audience members. Various components of the original version of the media content have been pre-tagged to describe the different parameters associated with the sub-components of the content filters. For example, assume that a specific passage in a movie has been previously classified at 7 for sports violence, 8 for language, and 3 for promoting a controversial worldview. In one embodiment, if any member of the audience should not be exposed to this passage (based on that member's profile), then that passage is removed and/or replaced with other more innocuous material.

In another embodiment, average sub-components of the content filter are generated based on all of the members of the audience. For example, if the average values for the content filter subcomponents for all members of the audience are 6 for sports violence, 9 for language, 5 for worldviews, then only passages that exceed these ratings are removed from the original version of the media content. A predetermination is made as to whether all or a certain percentage of parameters must be exceeded in order to take editing steps. Thus in one embodiment, the passage having a 7, 8, 3 ratings respectively for sports violence, language, and worldview would be removed since the passage's language level (9) exceeds the average acceptable language level (8). In another embodiment, the passage would be left in, since only one of the three parameter levels is exceeded compared to the average acceptable levels.

Referring now to block 310, the dynamically modified media content is then transmitted to a playback device, such as a video screen, a projector, an audio player, etc. The dynamically modified media content is in a form that has been edited in accordance with the audience profiles, as described herein. The process ends at terminator block 312.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the disclosure of the present application in detail and by reference to illustrative embodiments thereof, it will be apparent that modifications and variations are possible without departing from the scope of the disclosure defined in the appended claims.

What is claimed is:

1. A computer implemented method to modify media content to be presented to a media viewing audience, the computer implemented method comprising:
a processor generating at least one content filter, wherein each content filter is based on a member profile of a different member of a media viewing audience, and wherein each content filter comprises multiple sub-components that filter different parameters of the media content; and
the processor modifying a media content to create a dynamically modified media content based on the plurality of content filters.

2. The computer implemented method of claim 1, further comprising:
transmitting the dynamically modified media content to a playback device that is used to display the dynamically modified media content to the media viewing audience.

3. The computer implemented method of claim 1, further comprising:
averaging filter values from each of the multiple sub-components to establish an average content filter; and
applying the average content filter to the media content to create the dynamically modified media content.

4. The computer implemented method of claim 1, wherein the computer implemented method further comprises:
determining a most restrictive value for each of the multiple sub-components, wherein the most restrictive value describes a least tolerance to objectionable content as defined by the different parameters of the media content; and
utilizing the most restrictive value for each parameter of the plurality of content filters to create the dynamically modified media content.

5. The computer implemented method of claim 1, wherein the member profile for a specific member of the media viewing audience is established by:
providing a questionnaire about a specific member of the media viewing audience, wherein the questionnaire asks for an acceptable parameter level for each of the multiple sub-components of the content filter.

6. The computer implemented method of claim 5, further comprising:
utilizing the questionnaire to determine an level of violence that is acceptable for the specific member of the media viewing audience to be exposed to.

7. The computer implemented method of claim 5, further comprising:
utilizing the questionnaire to determine an acceptable worldview that is acceptable for the specific member of the media viewing audience to be exposed to.

8. The computer implemented method of claim 5, further comprising:
utilizing the questionnaire to determine an acceptable level of profanity that is acceptable for the specific member of the media viewing audience to be exposed to.

9. The computer implemented method of claim 5, wherein the media content is a movie, and wherein the member profile for a specific member of the media viewing audience is established by:
establishing content ratings for a plurality of movies;
utilizing the questionnaire to determine what movies are unacceptable for the specific member of the media viewing audience to watch; and
utilizing a content rating of an unacceptable movie to determine unacceptable content for removal from an original version of the media content.

10. The computer implemented method of claim 5, wherein the media content is a movie, and wherein the member profile for a specific member of the media viewing audience is established by:
establishing content ratings for a plurality of video games;
utilizing the questionnaire to determine what video games are unacceptable for the specific member of the media viewing audience to play; and
utilizing a content rating of an unacceptable video game to determine unacceptable content for removal from an original version of the media content.

11. The computer implemented method of claim 5, wherein the media content is a movie, and wherein the member profile for a specific member of the media viewing audience is established by:
establishing content ratings for a plurality of television shows;
utilizing the questionnaire to determine what television shows are unacceptable for the specific member of the media viewing audience to watch; and
utilizing a content rating of an unacceptable television show to determine unacceptable content for removal from an original version of the media content.

12. The computer implemented method of claim 5, wherein the member profile for a specific member of the media viewing audience is established by:
establishing content ratings for a plurality of books;
utilizing the questionnaire to determine which books are unacceptable for the specific member of the media viewing audience to read; and
utilizing a content rating of an unacceptable book to determine unacceptable content for removal from an original version of the media content.

13. The computer implemented method of claim 1, wherein each of the multiple sub-components comprises a sliding scale to qualitatively describe an acceptable amount of questionable content in an original version of the media content.

14. A computer system comprising:
a central processing unit; and
a memory coupled to the central processing unit, wherein the memory comprises software that, when executed, causes the central processing unit to implement:
generating a plurality of content filters, wherein each of the content filters is based on a member profile of a different member of a media viewing audience, and wherein each content filter comprises multiple sub-components that filter different parameters of the media content;
modifying a media content to create a dynamically modified media content based on the plurality of content filters; and
transmitting the dynamically modified media content to a playback device that is used to display the dynamically modified media content to the media viewing audience.

15. The computer system of claim 14, wherein the software, when executed, further causes the central processing unit to implement:
providing a questionnaire for a specific member of the media viewing audience, wherein the questionnaire asks for an acceptable parameter level for each of the multiple sub-components of the content filter.

16. The computer system of claim 14, wherein each of the multiple sub-components comprises a sliding scale to qualitatively describe an acceptable amount of questionable content in an original version of the media content.

17. A computer program product comprising:
a computer readable storage medium having computer readable program code embodied therewith, the computer readable program code comprising:
computer readable program code to generate a plurality of content filters, wherein each of the content filters is based on a member profile of a different member of a media viewing audience, and wherein each content filter comprises multiple sub-components that filter different parameters of the media content;
computer readable program code to modify a media content to create a dynamically modified media content based on the plurality of content filters; and
computer readable program code to transmit the dynamically modified media content to a playback device that is used to display the dynamically modified media content to the media viewing audience.

18. The computer program product of claim 16, wherein the computer readable program code further comprises:
computer readable program code to average filter values from each of the multiple sub-components to establish an average content filter; and
computer readable program code to apply the average content filter to the media content to create the dynamically modified media content.

19. The computer program product of claim 16, wherein the computer readable program code further comprises:
computer readable program code to provide a questionnaire for a specific member of the media viewing audience, wherein the questionnaire asks for an acceptable parameter level for each of the multiple sub-components of the content filter.

20. The computer program product of claim 16, wherein each of the multiple sub-components comprises a sliding scale to qualitatively describe an acceptable amount of questionable content in an original version of the media content.
